(19) United States
(12) Patent Application Publication
(10) Pub. No.: US 2005/0286712 A1
(43) Pub. Date: Dec. 29, 2005

(54) Telephone exchange apparatus, interface circuit used in the telephone exchange apparatus, and control method used for the telephone exchange apparatus

(76) Inventor: Mariko Koyama, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/878,230

(22) Filed: Jun. 29, 2004

(51) Int. Cl. H04M 1/00

(52) U.S. Cl. 379/399.01

(57) ABSTRACT

A telephone exchange apparatus which selectively sets an interface circuit connecting a communication line adapted to connect a telephone terminal and having a communication control function for the telephone terminal, and adapted to communicate between the communication line and another communication line by applying a voltage necessary for operation to the interface circuit includes a display which displays information representing an operating state of the interface circuit, in the interface circuit, a detector which detects whether the voltage applied to the interface circuit is more than a reference value, and generate a detection result, in the interface circuit and a controller which controls the display to display the information representing the operating state based on the detection result.

### BACKGROUND OF THE INVENTION

1. Field of the Invention

The present invention relates to a telephone exchange apparatus such as a PBX (Private Branch Exchange) or key telephone apparatus, an interface circuit set in the telephone exchange apparatus, and a control method used for the telephone exchange apparatus.

2. Description of the Related Art

Many telephone exchange apparatuses such as a PBX and key telephone apparatus have conventionally been used in office buildings and business offices. A telephone exchange apparatus of this type accommodates a telephone set or the like as an extension terminal. The telephone exchange apparatus enables speech communication by switching between the extension terminal and an external communication network such as a public network, and between extension terminals.

When a telephone exchange apparatus is to be purchased and used, the user generally selects a telephone exchange apparatus having a necessary extension terminal, outside line, voice mail device, and the like. However, an extension terminal, outside line, voice mail device, and the like must be added upon an increase in the staff, a change in business contents, or the like after the start of use. In this case, the user performs setting work of adding to the telephone exchange apparatus main body an extension interface (I/F) circuit which stores an extension terminal, an outside line I/F circuit which stores an outside line, and a voice mail I/F circuit which stores a voice mail device.

According to this addition method, when the telephone exchange apparatus is powered on while an I/F circuit is inserted half to the telephone exchange apparatus, an error such as a failure in using the telephone set or a failure in using voice mail occurs. The outer appearance of the telephone exchange apparatus does not indicate that the cause of the malfunction is half insertion of the I/F circuit. A long time is taken for finding out the cause of the malfunction.

The user cannot recognize half insertion of the I/F circuit. Thus, while the application voltage is unstable, a start-up process is executed, leading to a failure of a peripheral device.

### BRIEF SUMMARY OF THE INVENTION

It is an object of the present invention to provide a telephone exchange apparatus capable of, every time an abnormality occurs due to half insertion of an interface circuit, reliably detecting the abnormality and always holding stable operation, an interface circuit used in the telephone exchange apparatus, and a control method used for the telephone exchange apparatus.

According to an aspect of the present invention, there is provided a telephone exchange apparatus which selectively sets an interface circuit connecting a communication line adapted to connect a telephone terminal and having a communication control function for the telephone terminal, and adapted to communicate between the communication line and another communication line by applying a voltage necessary for operation to the interface circuit, comprising: a display which displays information representing an operating state of the interface circuit, in the interface circuit; a detector which detects whether the voltage applied to the interface circuit is more than a reference value, and generate a detection result, in the interface circuit; and a controller which controls the display to display the information representing the operating state based on the detection result.

According to another aspect of the present invention, there is provided an interface circuit used in a telephone exchange apparatus which selectively sets an interface circuit connecting a communication line adapted to connect a telephone terminal and having a communication control function for the telephone terminal, and adapted to communicate between the communication line and another communication line by applying a voltage necessary for operation to the interface circuit, comprising: a display which displays information representing an operating state of the interface circuit; a detector which detects whether the applied voltage is more than a reference value, and generate a detection result; and a controller which controls the display to display the information representing the operating state based on the detection result.

According to yet another aspect of the present invention, there is provided a control method used for a telephone exchange apparatus which selectively sets an interface circuit connecting a communication line adapted to connect a telephone terminal and having a communication control function for the telephone terminal, and adapted to communicate between the communication line and another communication line by applying a voltage necessary for operation to the interface circuit, comprising: detecting whether the voltage applied to the interface circuit is more than a reference value, to generate a detection result; and displaying information representing an operating state of the interface circuit based on the detection result.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the configuration of main part of a key telephone system according to the present invention;

FIG. 2 is a perspective view showing a state in which an interface board is accommodated in a main apparatus according to the first embodiment of the present invention;

FIG. 3 is a block diagram showing the arrangement of the interface board according to the first embodiment;

FIG. 4 is a flowchart showing the process sequence of the interface board according to the first embodiment;

FIG. 5 is a block diagram showing the arrangement of an interface board according to the second embodiment of the present invention; and

FIG. 6 is a flowchart showing the process sequence of the interface board according to the second embodiment.

### DETAILED DESCRIPTION OF THE INVENTION

Preferred embodiments of the present invention will be described in detail below with reference to the several views of the accompanying drawing.

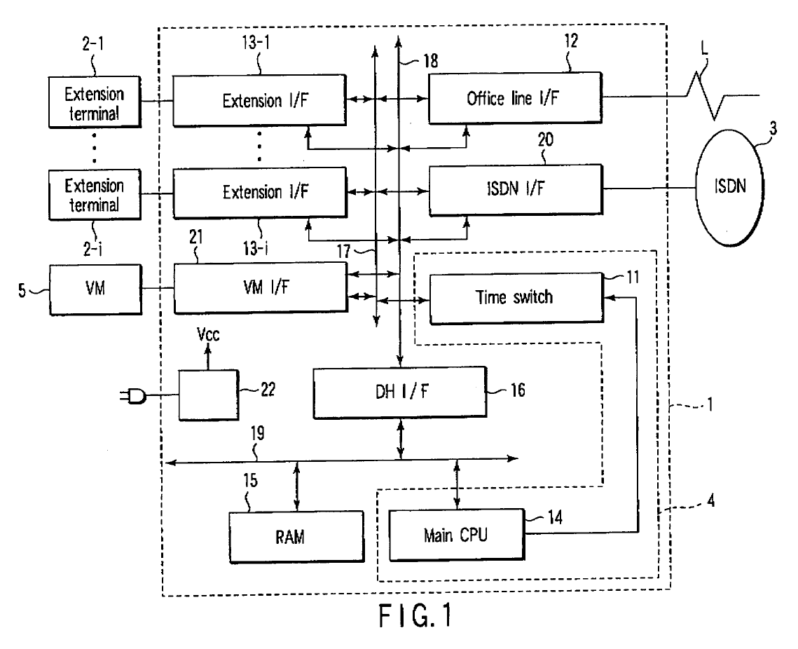

FIG. 1 is a block diagram showing the configuration of main part of a key telephone system according to the present invention.

As shown in FIG. 1, the key telephone system is built by arbitrarily connecting a plurality of (i at maximum) extension terminals 2 (2-1 to 2-i) to a main apparatus 1 via extensions. Each extension terminal 2 includes, e.g., a key telephone set.

The main apparatus 1 further comprises a time switch 11 (to be referred to as a TSW 11 hereinafter), an office line interface circuit 12 (to be referred to as an office line I/F 12 hereinafter), a plurality of (i) extension interface circuits 13 (13-1 to 13-i), a controller 14 (to be referred to as a main CPU 14 hereinafter), a storage 15 (to be referred to as a RAM 15 hereinafter), and a data highway interface (to be referred to as a DH I/F 16 hereinafter). The TSW 11, office line I/Fs 12, and extension I/Fs 13 are connected to each other via a PCM highway 17.

The office line I/Fs 12, extension I/SFs 13, and DH I/F 16 are connected to each other via a data highway 18. The TSW 11, main CPU 14, RAM 15, and DH I/F 16 are connected to each other via a CPU bus 19.

The TSW 11 arbitrarily switches between the extension I/Fs 13 and between the office line I/Fs 12 and the extension I/Fs 13 under the control of the main CPU 14.

The office line I/F 12 is connected to an office line L such as a public network or leased line, as needed. The office line I/F 12 performs office line interface operation associated with the connected office line L. Office line interface operation includes conversion of an audio signal (analog) supplied via the office line L into a PCM signal, conversion of a PCM signal supplied via the TSW 11 into an audio signal (analog), monitoring of the state of the office line L, and sending of various signals to a network connected via the office line L. The office line I/F 12 exchanges various pieces of control information on office line interface operation with the main CPU 14 via the data highway 18, DH I/F 16, and CPU bus 19.

The extension I/F 13 is connected to the extension terminal 2, as needed. The extension I/F 13 performs extension interface operation associated with the connected extension terminal 2. Extension interface operation includes extraction of a PCM signal output by the extension terminal 2 from the PCM highway 17, monitoring of the state of the extension terminal 2, and sending of various signals to the extension terminal 2. The extension I/F 13 exchanges various pieces of control information on extension interface operation with the main CPU 14 via the data highway 18, DH I/F 16, and CPU bus 19.

The DH I/F 16 exchanges data between the data highway 18 and the CPU bus 19.

The PCM highway 17 and data highway 18 are connected to an ISDN interface circuit 20 (to be referred to as an ISDN I/F 20 hereinafter). The ISDN I/F 20 is connected to an ISDN 3 serving as a digital communication network, as needed. The ISDN I/F 20 performs interface operation associated with the connected ISDN 3. The ISDN I/F 20 exchanges various pieces of control information on interface operation with the main CPU 14 via the data highway 18, DH I/F 16, and CPU bus 19.

The TSW 11 and main CPU 14 are mounted on a main board 4.

The PCM highway 17 and data highway 18 are connected to a voice mail interface 21 (to be referred to as a VM I/F 21 hereinafter). The VM I/F 21 is connected to a voice mail device 5 (to be referred to as a VM 5 hereinafter), as needed. The VM I/F 21 performs interface operation associated with the connected VM 5. The VM I/F 21 exchanges various pieces of control information on interface operation with the main CPU 14 via the data highway 18, DH I/F 16, and CPU bus 19.

Reference numeral 22 denotes a power supply which generates a predetermined DC power supply voltage Vcc based on a commercial power supply output and applies the DC power supply voltage vcc to all the circuits within the main apparatus 1.

### First Embodiment

The first embodiment is directed to a VM I/F 21 in FIG. 1.

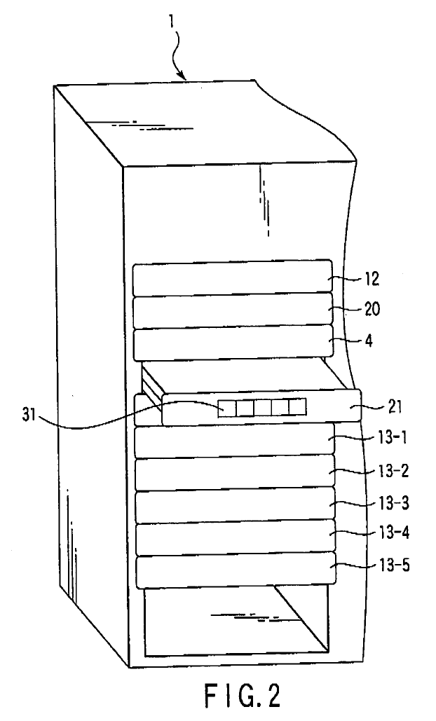

FIG. 2 is a perspective view showing a state in which the VM I/F 21 according to the first embodiment is accommodated in a main apparatus 1.

The main apparatus 1 accommodates a main board 4, an office line I/F 12, extension I/Fs 13-1 to 13-i (FIG. 2 illustrates only extension I/Fs 13-1 to 13-5), an ISDN I/F 20, and the VM I/F 21 so that they are freely detachable in the back and forth direction.

The front surface of the VM I/F 21 is equipped with a plurality of LEDs (Light Emitting Diodes) 31. The back surface of the VM I/F 21 is equipped with a power supply terminal for applying a voltage, and pluralities of input terminals and output terminals for exchanging audio signals and control signals.

When the VM I/F 21 is inserted into the opening of the main apparatus 1 from the surface having the power supply terminal, input terminals, and output terminals, the VM I/F 21 are connected to a plurality of terminals arranged inside the opening.

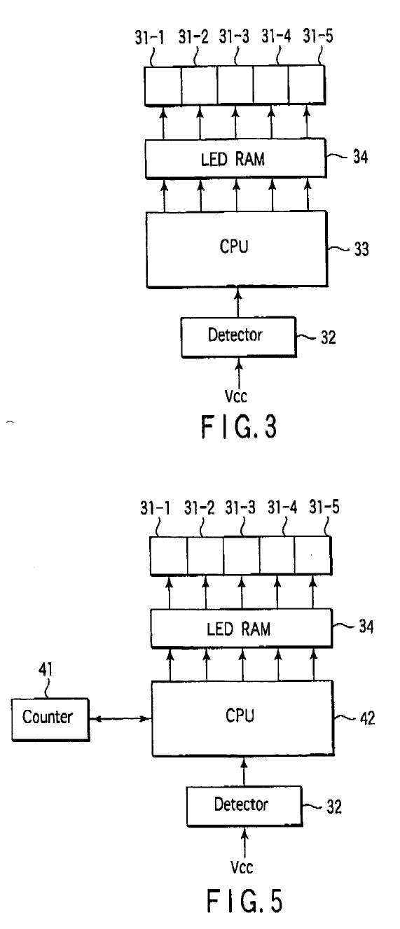

The VM I/F 21 has the following circuit arrangement. FIG. 3 is a block diagram showing this arrangement.

More specifically, the VM I/F 21 comprises a voltage detector 32, CPU 33, and LED RAM 34. The voltage detector 32 detects whether the voltage value Vcc applied from the power supply 22 is equal to or larger than a reference value. The detection result is supplied to the CPU 33.

The CPU 33 processes a communication signal to be transmitted to the VM 5 and a communication signal incoming from the VM 5 under the control of the main CPU 14. The CPU 33 writes, in the LED RAM 34, ON pattern data representing the operating state of the VM I/F 21 on the basis of the detection result of the voltage detector 32. In response to this, the LED RAM 34 selectively turns on the LEDs 31-1 to 31-5 in accordance with the written ON pattern.

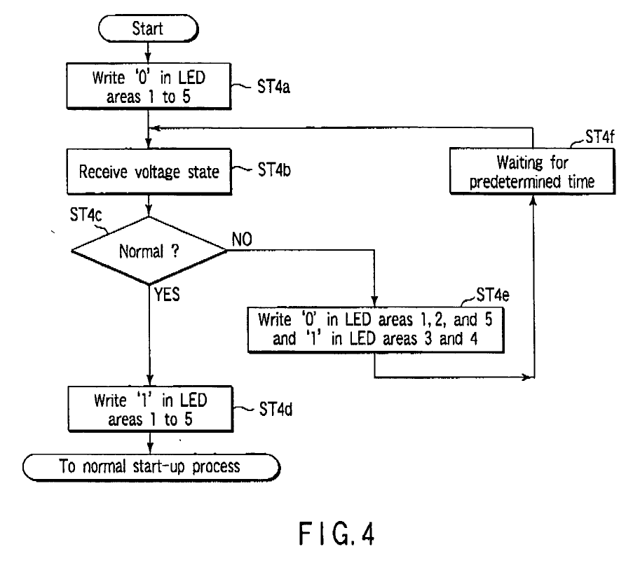

The operation in this arrangement will be explained. FIG. 4 is a flowchart showing the process sequence of the CPU 33.

When the main apparatus 1 is powered on, the CPU 33 writes “0” representing ON in areas of the LED RAM 34 that correspond to the LEDs 31-1 to 31-5 (step ST4a). The CPU 33 receives a detection result supplied from the voltage detector 32 (step ST4b), and determines from the detection result whether the voltage value Vcc is equal to or larger than a reference value (step ST4c).

If the voltage value Vcc is equal to or larger than the reference value (YES), the CPU 33 writes “1” representing OFF in areas of the LED RAM 34 that correspond to the LEDs 31-1 to 31-5 (step ST4d), and shifts to a normal start-up process.

If the VM I/F 21 is inserted half and the voltage value vcc is smaller than the reference value (NO), the CPU 33 writes “0” representing ON in areas of the LED RAM 34 that correspond to the LEDs 31-1, 31-2, and 31-5, and “1” representing OFF in areas that correspond to the LEDs 31-3 and 31-4 (step ST4e). After the CPU 33 waits for a predetermined time (step ST4f), it shifts to the process of step ST4b.

The CPU 33 keeps the LEDs 31-1 to 31-5 ON with the ON pattern representing half insertion until the VM I/F 21 is normally inserted. When the VM I/F 21 is normally inserted, the CPU 33 turns off all the LEDs 31-1 to 31-5, and then executes the normal start-up process.

As described above, according to the first embodiment, whether the voltage value Vcc applied from the power supply 22 is equal to or larger than the reference value is determined by the voltage detector 32 incorporated in the VM I/F 21 for the VM I/F 21 set in the main apparatus 1. When the CPU 33 determines that the voltage value Vcc is smaller than the reference value, the LEDs 31-1 to 31-5 display a message that the VM I/F 21 is inserted half to the main apparatus 1.

The user can instantly recognize that the VM I/F 21 is inserted half to the main apparatus 1, and can quickly take a measure. The main apparatus 1 can always be operated stably.

In the first embodiment, the state of the VM I/F 21 is displayed using the LEDs 31-1 to 31-5. A relatively low-cost VM I/F 21 can be implemented without any need for a special display.

### Second Embodiment

The second embodiment is directed to a VM I/F 21 in FIG. 1.

FIG. 5 is a block diagram showing the circuit arrangement of the VM I/F 21 according to the second embodiment. In FIG. 5, the same reference numerals as those in FIG. 3 denote the same parts, and a detailed description thereof will be omitted.

The second embodiment further adopts a counter 41. More specifically, when a CPU 42 determines on the basis of the detection result of a voltage detector 32 that the operating state of the VM I/F 21 is normal, the CPU 42 increments the count value of the counter 41, When the count value reaches a predetermined value “3”, the CPU 42 writes, in an LED RAM 34, ON pattern data representing that the VM I/F 21 is normal.

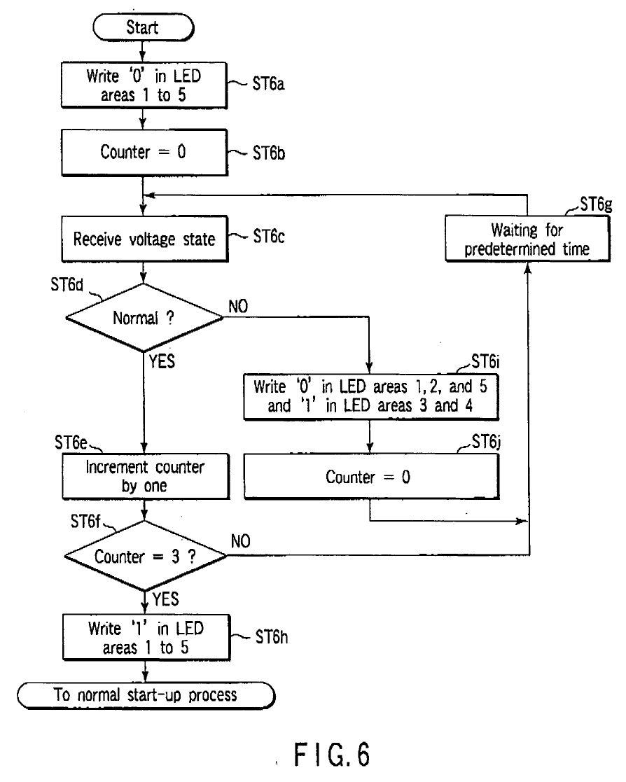

The operation in this arrangement will be explained. FIG. 6 is a flowchart showing the process sequence of the CPU 42.

When a main apparatus 1 is powered on, the CPU 42 writes “0” representing ON in areas of the LED RAM 34 that correspond to LEDs 31-1 to 31-5 (step ST6a). The CPU 42 resets the count value of the counter 41 to “0” (step ST6b).

The CPU 42 receives a detection result supplied from the voltage detector 32 (step ST6c), and determines from the detection result whether the voltage value Vcc is equal to or larger than a reference value (step ST6d).

If the voltage value Vcc is equal to or larger than the reference value (YES), the CPU 42 increments the count value of the CPU 42 by one (step ST6e), and determines whether the count value is “3” (step ST6f). Every time a predetermined time has elapsed (step ST6g), the CPU 42 repetitively executes the processes of steps ST6c to ST6e until the count value reaches “3”.

When the count value of the counter 41 reaches “3”, the CPU 42 writes “1” representing OFF in areas of the LED RAM 34 that correspond to the LEDs 31-1 to 31-5 (step ST6h), and shifts to a normal start-up process.

If the VM I/F 21 is inserted half and the voltage value Vcc is smaller than the reference value (NO), the CPU 42 writes “0” representing ON in areas of the LED RAM 34 that correspond to the LEDs 31-1, 31-2, and 31-5, and “1” representing OFF in areas that correspond to the LEDs 31-3 and 31-4 (step ST6i). The CPU 42 resets the counter 41 (step ST6j), and shifts to the process of step ST6g.

As described above, according to the second embodiment, when the CPU 42 detects that the voltage value Vcc equal to or larger than the reference value is applied to the VM I/F 21, whether the voltage equal to or larger than the reference value is applied to the VM I/F 21 is detected again by the voltage detector 32 prior to the start-up process of the main apparatus 1. When the counter 41 detects three times a message that the voltage value Vcc equal to or larger than the reference value is applied, the LEDs 31-1 to 31-5 display normal operation of the VM I/F 21.

An operating state monitoring process appropriate for the VM I/F 21 can be achieved to increase the monitoring reliability.

### Other Embodiments

The present invention is not limited to the above embodiments. The above embodiments have explained the VM I/F, but the present invention can also be applied to the extension I/F, office line I/F, ISDN I/F, and main board.

In the second embodiment, a message that the operating state of the VM I/P is normal is displayed when the count value reaches “3”. The count value may be arbitrarily set in accordance with an interface board for use.

The above embodiments target a key telephone system, but the present invention can also be applied to a digital private branch exchange system.

In addition, the arrangement of the main apparatus, the arrangement of the interface board, the detection method and display method of the operating state of the interface board, and the like can also be variously modified and practiced without departing from the spirit and scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A telephone exchange apparatus which selectively sets an interface circuit connecting a communication line adapted to connect a telephone terminal and having a communication control function for the telephone terminal, and adapted to communicate between the communication line and another communication line by applying a voltage necessary for operation to the interface circuit, comprising:
a display which displays information representing an operating state of the interface circuit, in the interface circuit;
a detector which detects whether the voltage applied to the interface circuit is more than a reference value, and generate a detection result, in the interface circuit; and
a controller which controls the display to display the information representing the operating state based on the detection result.

2. An apparatus according to claim 1, wherein the controller controls the detector to detect again whether the voltage is more than the reference value, a predetermined time after the voltage more than the reference value is detected.

3. An apparatus according to claim 2, wherein the controller controls the display to display information representing normal operation of the interface circuit, when the detector detects a predetermined number of times that the voltage is more than the reference value.

4. An apparatus according to claim 1, wherein the display comprises
a plurality of light-emitting elements, and
an emission controller which controls the plurality of light-emitting elements to emit light from at least one of the plurality or light-emitting elements to display the information representing the operating state.

5. An interface circuit used in a telephone exchange apparatus which selectively sets an interface circuit connecting a communication line adapted to connect a telephone terminal and having a communication control function for the telephone terminal, and adapted to communicate between the communication line and another communication line by applying a voltage necessary for operation to the interface circuit, comprising:
a display which displays information representing an operating state of the interface circuit;
a detector which detects whether the applied voltage is more than a reference value, and generate a detection result; and
a controller which controls the display to display the information representing the operating state based on the detection result.

6. A circuit according to claim 5, wherein the controller controls the detector to detect again whether the voltage is more than the reference value, a predetermined time after the voltage more than the, reference value is detected.

7. A circuit according to claim 6, wherein the controller controls the display to display information representing normal operation, when the detector detects a predetermined number of times that the voltage is more than the reference value.

8. A circuit according to claim 5, wherein the display comprises
a plurality of light-emitting elements, and
an emission controller which controls the plurality of light-emitting elements to emit light from at least one of the plurality of light-emitting elements to display the information representing the operating state.

9. A control method used for a telephone exchange apparatus which selectively sets an interface circuit connecting a communication line adapted to connect a telephone terminal and having a communication control function for the telephone terminal, and adapted to communicate between the communication line and another communication line by applying a voltage necessary for operation to the interface circuit, comprising:
detecting whether the voltage applied to the interface circuit is more than a reference value, to generate a detection result; and
displaying information representing an operating state of the interface circuit based on the detection result.

10. A method according to claim 9, further comprising;
detecting again whether the voltage is more than the reference value, a predetermined time after the voltage more than the reference value is detected.

11. A method according to claim 10, wherein the displaying includes displaying information representing normal operation, when the voltage more than the reference value is detected a predetermined number of times.
